(19) United States
(12) Patent Application Publication
(10) Pub. No.: US 2025/0078352 A1
(43) Pub. Date: Mar. 6, 2025

(54) AUTOMATED STORY GENERATION SYSTEM

(71) Applicant: Burak Sezer, West Haven, CT (US)

(72) Inventor: Burak Sezer, West Haven, CT (US)

(21) Appl. No.: 18/614,236

(22) Filed: Mar. 22, 2024

Related U.S. Application Data
(60) Provisional application No. 63/454,504, filed on Mar. 24, 2023.

(51) Int. Cl. G06T 11/60; G06F 40/279; G06F 40/40

(52) U.S. Cl. CPC G06T 11/60; G06F 40/279; G06F 40/40

(57) ABSTRACT

A method of creating an electronic story is disclosed. A user prompt may be received at a story generation server. The user prompt may be submitted to an artificial intelligence system trained using previously written stories. The text may be communicated to a scene generation system where the scene generation system may analyze the text for scene information, determine scene information and communicate scene information to a graphics processor. In the graphics processor, graphics may be generated for the story based on the scene information.

### RELATED APPLICATIONS

This application claims the benefit of U.S. Provisional Patent Application No. 63/454,504 filed Mar. 24, 2023, which is incorporated by reference herein in its entirety.

### BACKGROUND

In the past, books were created on paper. Pages were turned by hand. In some cases, interesting parts were highlighted or underlined. In more recent times, books have been viewed on electronic devices. Pages are turned using a tap on a screen or selecting an input. In addition, as books have become electronic, creating or changing the text and/or the images to be more relevant and visually appealing images has become possible. In addition, writing books took a significant amount of time and the contents may have been relevant to some people but not others.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

A system and method of creating an electronic story is disclosed. A user prompt may be received at a story generation server. The user prompt may be submitted to an artificial intelligence system trained using previously written stories. Using the artificial intelligence system, text may be generated for an electronic story file. The text may be communicated to a scene generation system where the scene generation system may analyze the text for scene information, determine scene information and communicate scene information to a graphics processor. In the graphics processor, graphics may be generated for the story based on the scene information. These graphics can either be images, animated images, graphics, or videos generated from text to image and/or text to video AI models.

### BRIEF DESCRIPTION OF THE DRAWINGS

FIG. 1 may be an illustration of a method in accordance with the claims;

FIG. 1a may be an illustration of an artificial learning system used with the claims;

FIG. 1b may be an illustration of a convolutional neural network;

FIG. 2 may be an illustration of a display illustrating an image operating in accordance with the claims;

FIG. 3 may be an illustration of a display illustrating an image operating in accordance with the claims;

FIG. 4 may be an illustration of a display illustrating an image operating in accordance with the claims where a page is turned;

FIG. 5 may be an illustration of a display illustrating an image operating in accordance with the claims where a user's hand is added to an augmented reality and/or virtual reality display;

FIG. 6 may be an illustration of a display illustrating an image operating in accordance with the claims;

FIG. 7 may an illustration of a method of creating graphics for a story in accordance with the claims;

FIG. 8a may be an illustration of an immersive display in accordance with the claims;

FIG. 8b may be an illustration of an immersive display in accordance with the claims; and

FIG. 9 may be an illustration of the system used to execute the method.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SPECIFICATION

The present disclosure now will be described more fully hereinafter with reference to the accompanying drawings, which form a part hereof, and which show, by way of illustration, specific exemplary embodiments by which the disclosure may be practiced. These illustrations and exemplary embodiments are presented with the understanding that the present disclosure is an exemplification and is not intended to be limited to any one of the embodiments illustrated. The disclosure may be embodied in many different forms and should not be construed as limited to the embodiments set forth herein; rather, these embodiments are provided so that this disclosure will be thorough and complete, and will fully convey the scope of the disclosure to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

The described system and method provides a technical solution to both create electronic stories and how to display them.

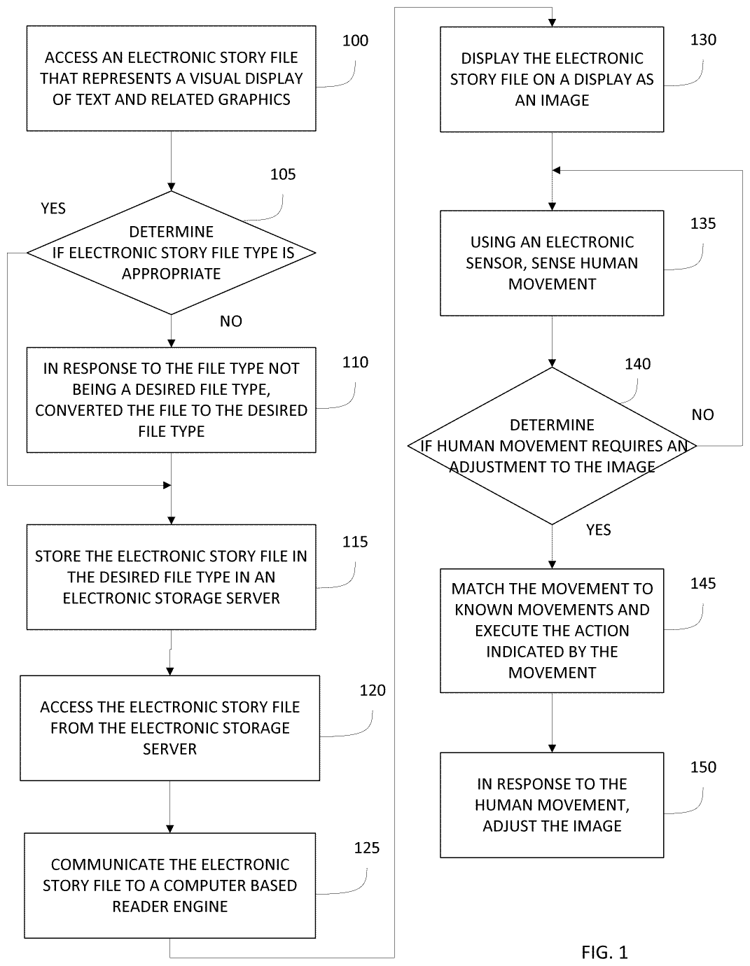

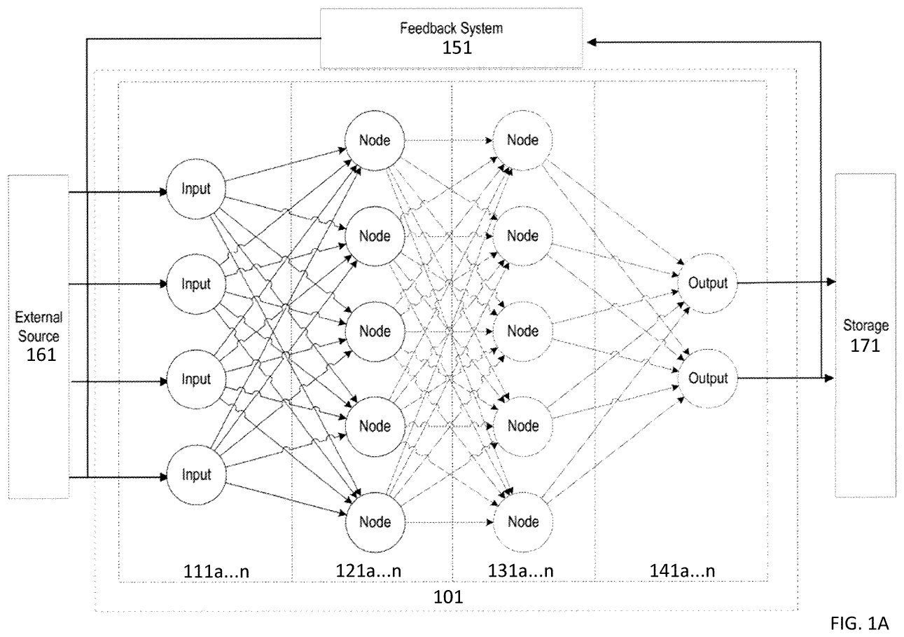

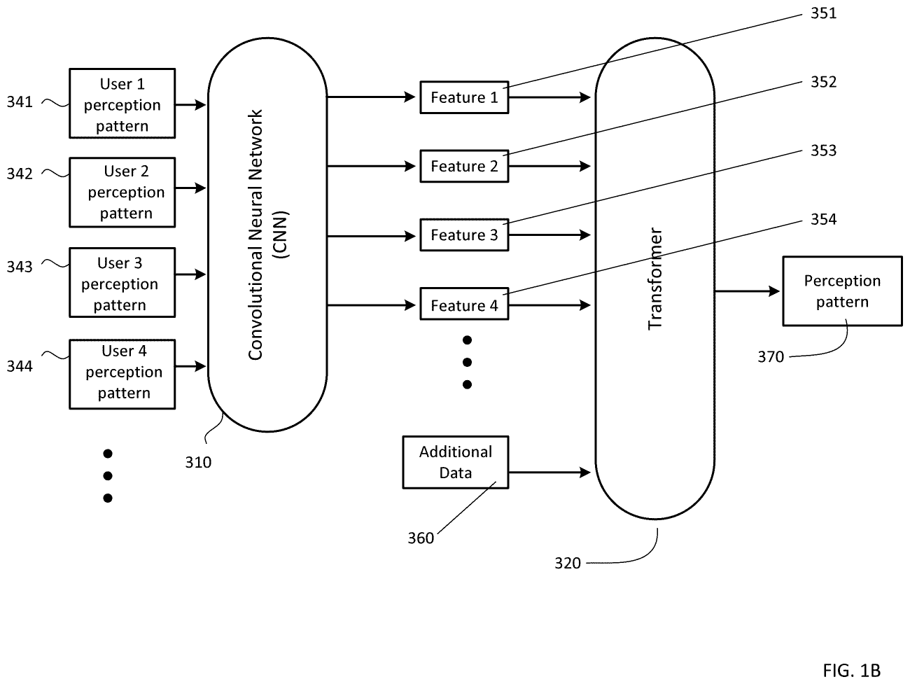

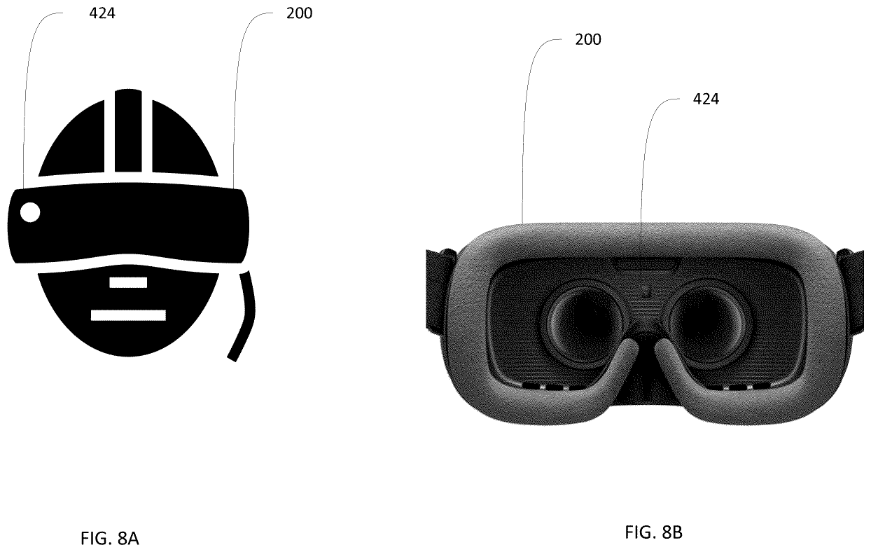

Referring to FIG. 1, a method of improving a display of a page may be disclosed. At block 100, an electronic story file that represents a visual display of text and related graphics may be assessed. The file may be in one of several known formats. The file may be encrypted such that only authorized users may access the file. The electronic story file may include both text and graphics where the graphics may be related to the text and the graphics may be static images, animated images or videos. The electronic story file may be designed to be displayed in two dimensions, three dimensions or on a traditional display or in a virtual reality, mixed reality or an augmented reality viewing device such as a device illustrated in FIGS. 8a and 8b such as an Oculus device, a Sony PlayStation VR viewer, Microsoft HoloLens, Google DayDream, Samsung HMD Odyssey, etc. Logically, the type of displays are many and varied, will improve over time and these many displays are all contemplated.

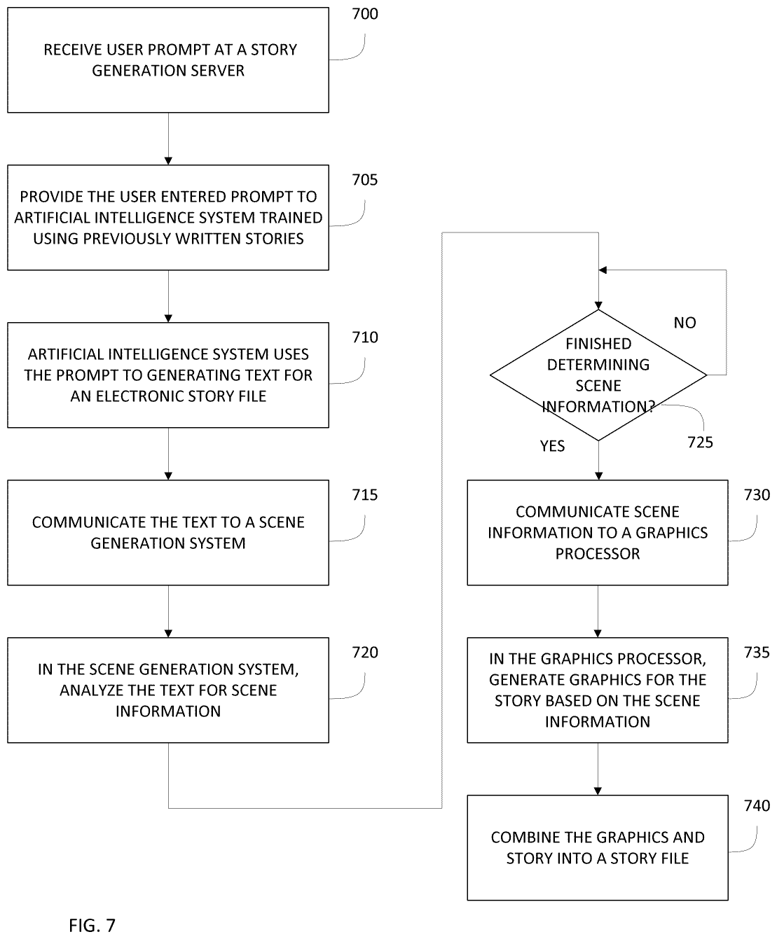

The electronic story file may exist or may be created using machine learning and/or artificial intelligence. For files that exist, the files may be accessed from an online store, may be downloaded from a library or may be available in any other appropriate storage medium. As for stories that are created, more detail is discussed in relation to FIG. 7.

At block 105, the electronic story file may be analyzed to determine a file type. Some file types may be immediately recognized and be ready for display. Other file types may need to be modified to be displayed. Other file types may need to be modified to take advantage of the display device. For example, a .pdf file may be rich in text, color and images but may not be adapted to take advantage of a virtual reality display device. An augmented video device may be capable of using video or audio files such as mp4, m4v, 3gp, g2, webm, mkv, wmv, avi, mp3 and aac. Logically, virtually any image file type such as .jpeg or .png may be used depending on the intended display. For example, a .jpeg file may be displayed on an augmented reality viewer even if the .jpeg file does not take advantage of all the capabilities of the augmented reality viewer.

At block 110, in response to the file type not being a desired file type, the file may be converted to the desired file type. Some sample converters may include but are not limited to VideoProc Converter, Wondershare Uniconverter, Pavtube Video Converter, iFun Video Converter, VideoSolo Video Converter Ultimate. Of course, other converters are available and are contemplated.

At block 115, the electronic story file may be stored in the desired file type in an electronic storage server. The electronic server may be designed and built for bulk storage and quick retrieval of the files as consistent, quick delivery of the electronic files to users may be important to users. The electronic storage server also may be a plurality of servers linked together in a cloud type of arrangement. The servers may be configured for high speed communications.

At block 120, the electronic story file may be accessed from the electronic storage server. The story file may be accessed using an application programing interface (API). The API may receive a request in a specific format and will respond with the electronic story file in an expected format. The access may also require the use of electronic keys or encryption to ensure only authorized users may access the electronic story file.

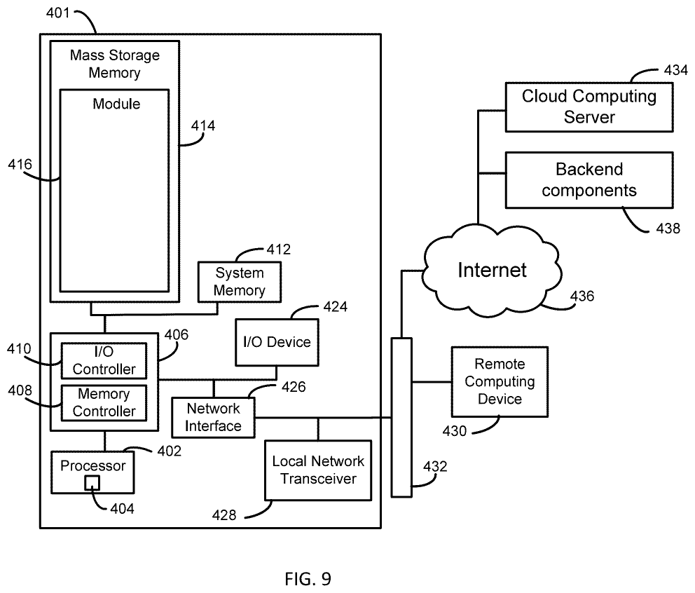

At block 125, the electronic story file may be communicated to a computer based reader engine. A sample computer 700 may be illustrated in FIG. 9. The computer based reader engine may be physically configured to be able to quickly and efficiently read the electronic story file and convert it into graphics which may be images, videos, animations, graphics, or images or graphics made up of text and possibly images to be displayed to a user. For example, as the end result is an image displayed to a user, a processor with improved graphics may be appropriate to be part of the computer based reader engine.

At block 130, the electronic story file may be displayed on a physical display 200 as an image, graphic or video 201. Logically, the image 201 may have text, images, animations, movies or a combination of text and images similar to a paper book or videos, animated images, etc. In some embodiments, the display 200 may be a two dimensional display such as a traditional web site display on a monitor. In other embodiments, the display 200 may be a three dimensional display and the display may contain moving images. In yet other embodiments, the display 200 may be a wearable display 200 such as an augmented reality display or a virtual reality display as illustrated in FIGS. 8a and 8b. The electronic story file may be adapted to be best displayed on the type of display 200 being used.

In some embodiments, the user may select to have the reader engine sound out the text or dialogue in the electronic story file. Numerous apps exist to read text such as Speechify, NaturalReader, Browse Aloud, Voice Dream Reader, and Read & Write. In addition, the reader engine may be able to describe the images and videos that are related to the text.

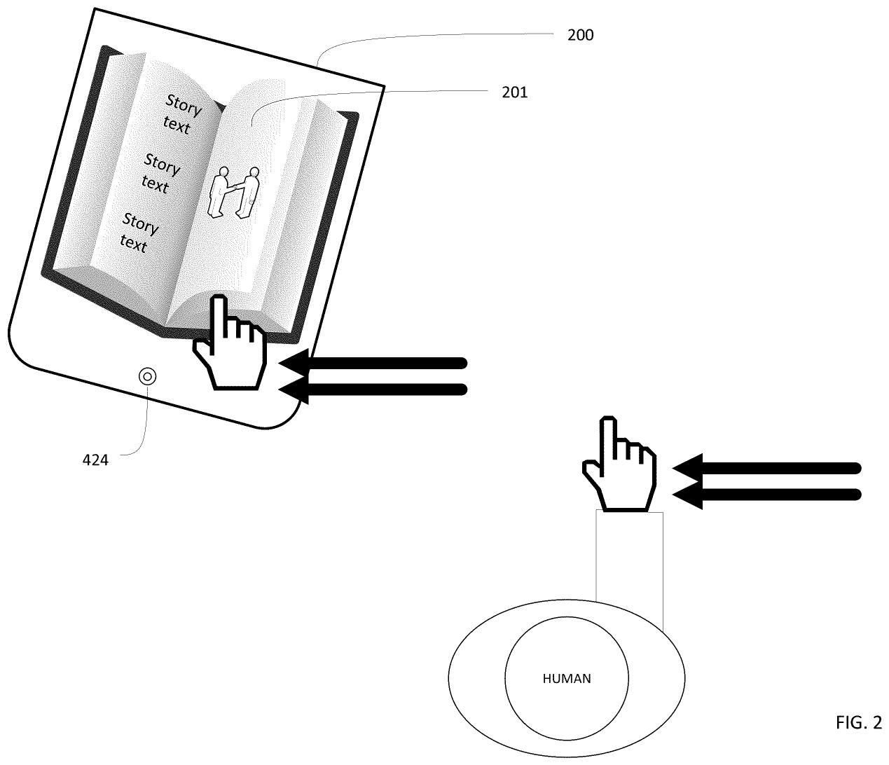

At block 135, using an electronic sensor 403, human movement may be sensed using an electronic sensor such as illustrated in FIG. 2. The electronic sensor 403 may be a single sensor such as an image capture sensor or the electronic sensor may be a plurality of sensors that work together. The sensors 403 may sense human motion that is translated into an action on the display. In addition, the human motion may result in an action being displayed on the image 201 on the display 200.

As an example and not limitation, an input output device 424 such as an image sensor may capture images of a user's hands such as in FIG. 2. If a user moves their hand in a horizontal motion, the sensor may capture that movement. The image sensor 424 may also observe the eyes of a user and eye movements may provide an indication that the display image 201 may be changed. Similarly, head rotations may be sensed by the electronic sensor 424 and may be analyzed to determine if a change in the display 201 is appropriate. Logically, small movements such as shoulder movements may be captured and analyzed to determine if a change in the display is appropriate. A controller such as a joystick or touch pad may be used as the electronic sensor 424 and movements of the controller 424 may be captured and analyzed to determine if a change of the display is needed. Other electronic sensors 424 may include a sound sensor such a microphone. Verbal inputs may be captured and analyzed to determine if a change in the display is appropriate.

In some embodiments, the electronic sensor 424 may be mounted in the VR headset 200 or the AR headset 200 (FIGS. 8a and 8b). In other embodiments such as a two dimensional reader 200, the electronic sensor 424 may be mounted in the electronic reader and may face the user. In other embodiments, the electronic sensor 424 may be a separate imaging or motion sensing device that is in communication with the electronic reading device 200.

At block 140 using an analysis engine on a processor, the human movement may be analyzed to determine if the actions require an adjustment to the image. Analyzing the human movement to determine if the actions require an adjustment to the image may have a variety of approaches. In one approach, a human movement may be stored at a first point in time. For example, the position of a hand may be stored at a first point in time. A human movement may be stored at a second point in time. Continuing the example, the position of the same hand may be stored at a second point in time. The difference of the human movement at the first point in time to the human movement at the second point in time may be determined. For example, the hand may move in a horizontal direction from the first point in time to the second point in time. It may be determined if the movement from the first point in time to the second point in time is over a threshold. For example, a small twitch of a hand may not be over the threshold while a sweeping motion of a hand may be over the threshold.

The threshold may be adjusted and improved over time using machine learning and/or artificial intelligence. For example, if the threshold is too low, every twitch by a user may trigger a change in the display and similarly, if the threshold is too high, intended movements may fall below the threshold and desired changes may not be made to the display. By obtaining feedback from the user, the threshold may be adjusted to obtain desired results.

Logically, the points in time may be adjusted to better capture the movements. For example, if the points in time are separated by 0.01 second, not much movement will be detected while if the points in time are separated by an hour, too much movement is likely. The system and method may use machine learning or artificial intelligence to improve the selection of the points in time to better match the intended movements of the user and avoid unintended movements causing the display to change. By obtaining feedback from the user, the points in time may be adjusted to obtain desired results.

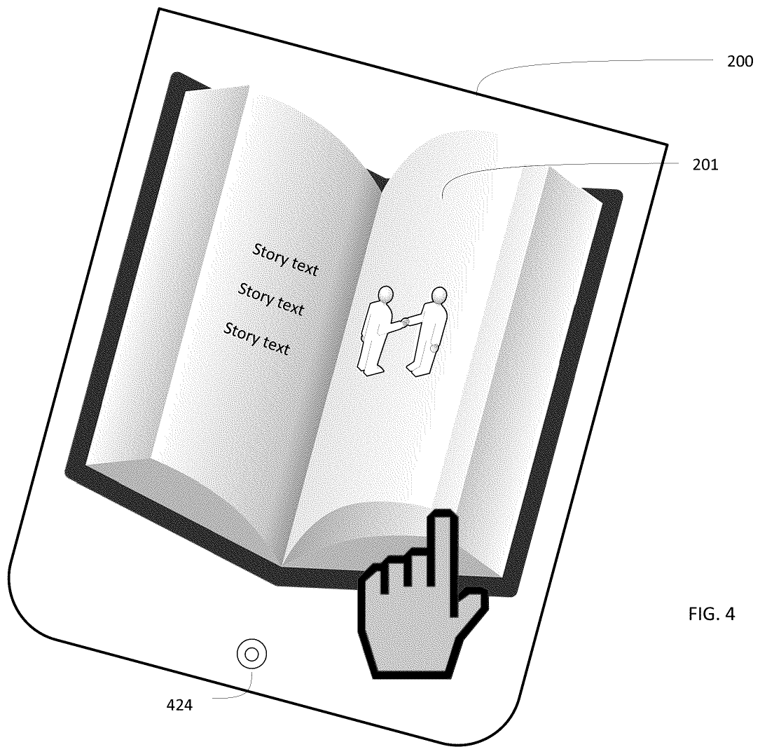

At block 145, the movement may be matched to known movements and the action indicated by the movement may be executed. As an example such as in FIG. 4, if a user makes a hand movement to turn a page, the movement may be matched to a page turning movement on the display. The matching may occur in a variety of ways.

In one embodiment, the user may “train” the method. More specifically, the system may ask the user to record physical movements that will be matched with actions on the display. The user may then record movements which will be used to match movements in the future with actions on the display.

In another embodiment, pre-recorded movements may be used as comparisons. In yet another embodiment, with user permissions, physical motions of other users and the matched actions may be used as the comparisons. The physical movements and matched actions may be stored in a virtual server such as in the cloud and may be analyzed using machine learning or artificial intelligence to better improve the system.

In yet another embodiment, the user may reject the proposed action that the system matched to the action. Thus the system may learn through negative responses as to what an action does not mean. The negative data may be analyzed by the machine learning and artificial learning systems to improve the matching ability of the system.

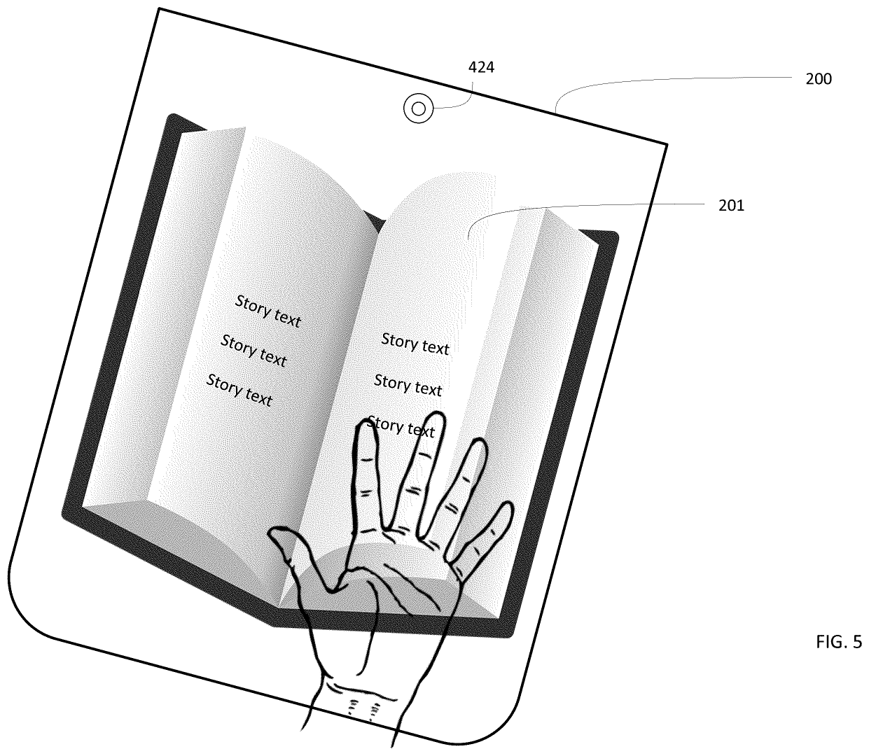

At block 150 in response the human movement, the image 201 may be adjusted. The adjustment may take on a variety of forms. In some embodiments, an animated hand may be displayed on the image 201 and may be animated to turn physically the page. In other embodiments such as in FIG. 5 where the user is using augmented reality display 200, the user's own hand may be captured and may be trimmed and displayed as turning the page of the virtual book.

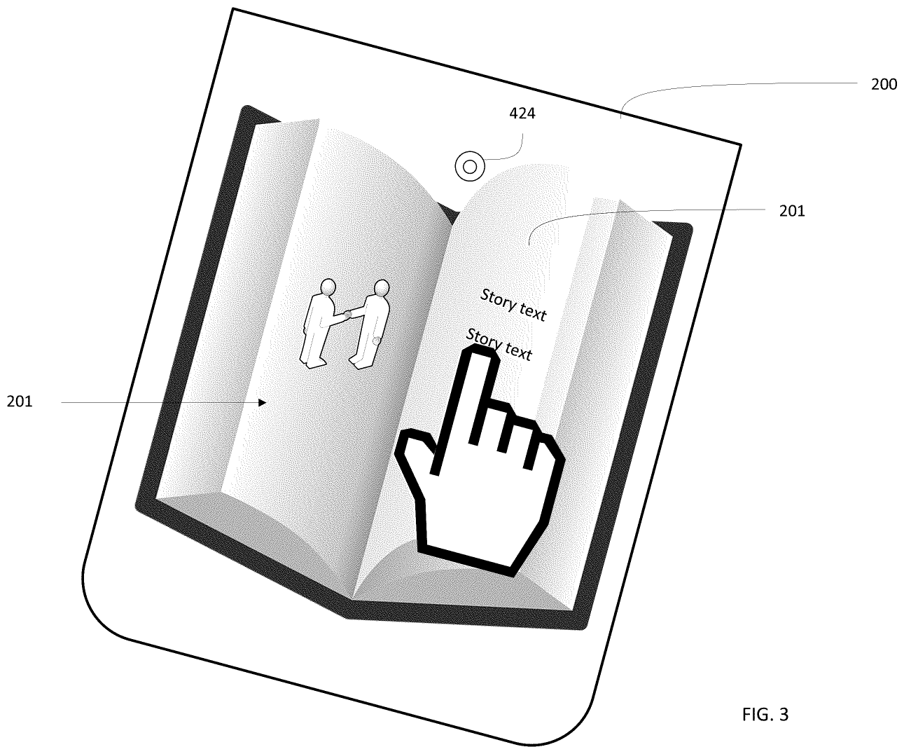

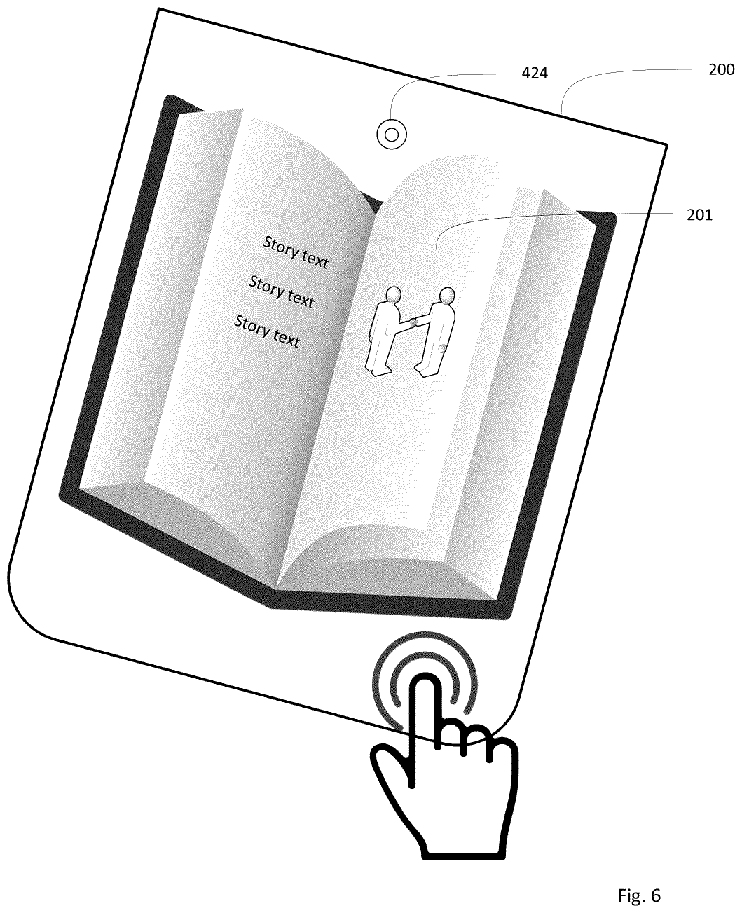

Similarly, if a user point a finger, in some embodiments such as in FIG. 3, text may be highlighted, underlined or cut/copied in relation to the movement of the finger or the finger may simply move along with the reading of the text such that a user may keep track of the current location in the electronic book. An additional menu may appear and a user may use a hand, finger, eye movement or other physical movement to select an option regarding what to do with the selected text such as illustrated in FIG. 6.

Logically, physical movements may be used to shrink or enlarge a page. For example, moving hands apart may indicate to enlarge a page and moving hands together may indicate an intent to shrink a page. Similarly, selected text may be shrunk or expanded.

In another aspect, the story and illustration that are displayed and modified may be created in a variety of ways. In some embodiments, a story and illustration may exist. In an additional embodiment such as described in FIG. 7, the story and illustrations may be created by artificial intelligence based on some cues provided by a user.

Referring to FIG. 7, at block 700, a user prompt may be received to be used at a story generation server. The prompt may be any word or phrase that the user would like to see as part of the story or be the focus of the story. Logically, more than one word of phrase may be communicated to the system. The purpose of the prompt may be to given the story some direction or guidance of what may interest the user.

At block 705, the user entered prompt may be provided to an artificial intelligence system trained using previously written stories. Artificial intelligence systems may break down previous stories into various elements. By studying the various elements, the artificial intelligence system may be able to determine some elements which are common in stories that are considered to be favorable by the intended audience. The purpose of the trained artificial intelligence system may be to create stories based loosely on previous stories.

At block 710, the artificial intelligence system may use the prompt to generate text for an electronic story file. The prompt may be classified and matched to elements in stories previously reviewed and analyzed. For example, if the prompt was “Ireland” the artificial intelligence system may base the story in Ireland and if the prompt was “giraffe” the artificial intelligence system may base the created story on a giraffe.

At block 715, the text may be communicated to a scene generation system. At a high level, the scene generation system may review the text of the story, identify elements of the created story that would be appropriate for illustration and may create the illustrations. The scene generation system may be used to create illustrations, which may be static or dynamic, that relate to the story and add visual interest to the story.

At block 720 in the scene generation system, the text may be analyzed for scene information. Common elements that may be reviewed may be the location of the elements in the story and any more specific details about the locations. The goal of the scene generation system may be to create illustrations, which may be static or dynamic, that relate to the story and add visual interest to the story. By analyzing story elements, relevant scenes may be generated.

At block 725, scene information may be determined. More than one location may be part of the story but some locations may be more important than other locations. For example, a flash back scene may be important to provide clues as to the future aspects of the story while a location that is mentioned in a joke may not be as important. Further, the locations may have details which are important to the scene such as a candlestick holder or a view out a window or the color of a carpet and these details may be determined as scene information.

At block 730 scene information may be communicated to a graphics processor. For example, a list of locations and location details may be communicated to the graphics processor. The graphics may create graphics which may be static or dynamic such as animations or movies. The communication may use a standard format or may use an API to communicate the scene information in a standard and efficient manner.

At block 735 in the graphics processor which may be similar to the processor in FIG. 9, graphics may be generated for the story based on the scene information. The graphics may be accessed from a library or may be generated by the graphics processor. In one embodiment, the graphic processor may utilize an artificial intelligence image diffusion model or text to video AI models to generate the graphics based on extracted scene and location information.

At block 740, the graphics may be images, animated images, graphics, or videos and the story may be combined into a story file. As mentioned previously, the graphics created may be in a variety of formats depending on the intended display. For example, the graphics may be created for an augmented reality display 200 or a virtual reality display 200 or a tablet display 200 or a traditional computer/laptop display. In some embodiments, a draft version of the illustrations may be created a user may be able to approve or disapprove the graphics such illustrated in FIG. 6.

In some embodiments, the electronic story file may be communicated to a user computing device or display 200 where it may be stored and viewed. The electronic story file may be communicated using a known protocol for accuracy, efficiency and security reasons. In some additional embodiments, the story file may be communicated to a web portal and a known protocol may be used. The electronic story file may accessed using an API. In some embodiments, the story file may be stored using encryption to ensure it is not copied.

### Machine Learning

Machine learning may be used to recognize patterns. The machine learning model may be trained on a model on an existing dataset and using the model to predict whether the claim matches a known pattern of claim resolution. The machine learning model may be used to predict future actions based on past pattern recognition. The machine learning model may also be used to determine pattern deviation. Logically, pattern deviation may be used to determine future actions.

A framework for machine learning algorithm like a large language model may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., candidate programs) are evaluated, including but not limited to as accuracy, prediction and recall, squared error, likelihood, posterior probability, cost, margin, entropy k-L divergence, and/or others. Optimization components refer to computing units that perform steps that generate candidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks (e.g., the human brain). Such structures, while significantly more complex than conventional computer systems, are beneficial in implementing machine learning. For example, an artificial neural network may be comprised of a large set of nodes which, like neurons in the brain, may be dynamically configured to effectuate learning and decision-making.

Machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator. Meanwhile, in supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of 100 photos with labeled human faces and 10,000 random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “75% correct”). An embodiment involving supervised machine learning is described herein.

As elaborated herein, in practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (4) interpreting results; and/or (5) consolidating and deploying discovered knowledge. This may further include conferring with domain experts to refine the goals and make the goals more clear, given the nearly infinite number of variables that can possible be optimized in the machine learning system. Meanwhile, one or more of data integration, selection, cleaning, and/or pre-processing steps can sometimes be the most time consuming because the old adage, “garbage in, garbage out,” also reigns true in machine learning systems.

By way of example, FIG. 1a illustrates a simplified example of an artificial neural network 101 on which a machine learning algorithm may be executed. FIG. 1a is merely an example of nonlinear processing using an artificial neural network; other forms of nonlinear processing may be used to implement a machine learning algorithm in accordance with features described herein.

In FIG. 1a, each of input nodes 111 a-n is connected to a first set of processing nodes 121 a-n. Each of the first set of processing nodes 121 a-n is connected to each of a second set of processing nodes 131 a-n. Each of the second set of processing nodes 131 a-n is connected to each of output nodes 141 a-n. Though only two sets of processing nodes are shown, any number of processing nodes may be implemented. Similarly, though only four input nodes, five processing nodes, and two output nodes per set are shown in FIG. 1a, any number of nodes may be implemented per set. Data flows in FIG. 1a are depicted from left to right: data may be input into an input node, may flow through one or more processing nodes, and may be output by an output node. Input into the input nodes 111 a-n may originate from an external source 161. Output may be sent to a feedback system 151 and/or to storage 171. The feedback system 151 may send output to the input nodes 111 a-n for successive processing iterations with the same or different input data.

In one illustrative method using feedback system 151, the system may use machine learning to determine an output. The output may include anomaly scores, heat scores/values, confidence values, and/or classification output. The system may use any machine learning model including xgboosted decision trees, auto-encoders, perceptron, decision trees, support vector machines, regression, and/or a neural network. The neural network may be any type of neural network including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tan h function, a ReLu function, and/or other functions. Moreover, the neural network may include a loss function. A loss function may, in some examples, measure a number of missed positives; alternatively, it may also measure a number of false positives. The loss function may be used to determine error when comparing an output value and a target value. For example, when training the neural network the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combination of techniques, to update weights in each layer. When appropriate, the neural network may include a mechanism to prevent overfitting—regularization (such as L1 or L2), dropout, and/or other techniques. The neural network may also increase the amount of training data used to prevent overfitting.

Once data for machine learning has been created, an optimization process may be used to transform the machine learning model. The optimization process may include (1) training the data to predict an outcome, (2) defining a loss function that serves as an accurate measure to evaluate the machine learning model's performance, (3) minimizing the loss function, such as through a gradient descent algorithm or other algorithms, and/or (4) optimizing a sampling method, such as using a stochastic gradient descent (SGD) method where instead of feeding an entire dataset to the machine learning algorithm for the computation of each step, a subset of data is sampled sequentially. In one example, optimization comprises minimizing the number of false positives to maximize a user's experience. Alternatively, an optimization function may minimize the number of missed positives to optimize minimization of losses from exploits.

In one example, FIG. 1a depicts nodes that may perform various types of processing, such as discrete computations, computer programs, and/or mathematical functions implemented by a computing device. For example, the input nodes 111 a-n may comprise logical inputs of different data sources, such as one or more data servers. The processing nodes 121 a-n may comprise parallel processes executing on multiple servers in a data center. And, the output nodes 141 a-n may be the logical outputs that ultimately are stored in results data stores, such as the same or different data servers as for the input nodes 111 a-n. Notably, the nodes need not be distinct. For example, two nodes in any two sets may perform the exact same processing. The same node may be repeated for the same or different sets.

Each of the nodes may be connected to one or more other nodes. The connections may connect the output of a node to the input of another node. A connection may be correlated with a weighting value. For example, one connection may be weighted as more important or significant than another, thereby influencing the degree of further processing as input traverses across the artificial neural network. Such connections may be modified such that the artificial neural network 101 may learn and/or be dynamically reconfigured. Though nodes are depicted as having connections only to successive nodes in FIG. 1a, connections may be formed between any nodes. For example, one processing node may be configured to send output to a previous processing node.

Input received in the input nodes 111 a-n may be processed through processing nodes, such as the first set of processing nodes 121 a-n and the second set of processing nodes 131 a-n. The processing may result in output in output nodes 141 a-n. As depicted by the connections from the first set of processing nodes 121 a-n and the second set of processing nodes 131 a-n, processing may comprise multiple steps or sequences. For example, the first set of processing nodes 120 a-n may be a rough data filter, whereas the second set of processing nodes 131 a-n may be a more detailed data filter.

The artificial neural network 101 may be configured to effectuate decision-making. As a simplified example for the purposes of explanation, the artificial neural network 101 may be configured to detect faces in photographs. The input nodes 111 a-n may be provided with a digital copy of a photograph. The first set of processing nodes 121 a-n may be each configured to perform specific steps to remove non-facial content, such as large contiguous sections of the color red. The second set of processing nodes 131 a-n may be each configured to look for rough approximations of faces, such as facial shapes and skin tones. Multiple subsequent sets may further refine this processing, each looking for further more specific tasks, with each node performing some form of processing which need not necessarily operate in the furtherance of that task. The artificial neural network 101 may then predict the location on the face. The prediction may be correct or incorrect.

The feedback system 151 may be configured to determine whether or not the artificial neural network 101 made a correct decision. Feedback may comprise an indication of a correct answer and/or an indication of an incorrect answer and/or a degree of correctness (e.g., a percentage). For example, in the facial recognition example provided above, the feedback system 151 may be configured to determine if the face was correctly identified and, if so, what percentage of the face was correctly identified. The feedback system 151 may already know a correct answer, such that the feedback system may train the artificial neural network 101 by indicating whether it made a correct decision. The feedback system 151 may comprise human input, such as an administrator telling the artificial neural network 101 whether it made a correct decision. The feedback system may provide feedback (e.g., an indication of whether the previous output was correct or incorrect) to the artificial neural network 101 via input nodes 111 a-n or may transmit such information to one or more nodes. The feedback system 151 may additionally or alternatively be coupled to the storage 171 such that output is stored. The feedback system may not have correct answers at all, but instead base feedback on further processing: for example, the feedback system may comprise a system programmed to identify faces, such that the feedback allows the artificial neural network 101 to compare its results to that of a manually programmed system.

The artificial neural network 101 may be dynamically modified to learn and provide better input. Based on, for example, previous input and output and feedback from the feedback system 151, the artificial neural network 101 may modify itself. For example, processing in nodes may change and/or connections may be weighted differently. Following on the example provided previously, the facial prediction may have been incorrect because the photos provided to the algorithm were tinted in a manner which made all faces look red. As such, the node which excluded sections of photos containing large contiguous sections of the color red could be considered unreliable, and the connections to that node may be weighted significantly less. Additionally or alternatively, the node may be reconfigured to process photos differently. The modifications may be predictions and/or guesses by the artificial neural network 101, such that the artificial neural network 101 may vary its nodes and connections to test hypotheses.

The artificial neural network 101 need not have a set number of processing nodes or number of sets of processing nodes, but may increase or decrease its complexity. For example, the artificial neural network 101 may determine that one or more processing nodes are unnecessary or should be repurposed, and either discard or reconfigure the processing nodes on that basis. As another example, the artificial neural network 101 may determine that further processing of all or part of the input is required and add additional processing nodes and/or sets of processing nodes on that basis.

The feedback provided by the feedback system 151 may be mere reinforcement (e.g., providing an indication that output is correct or incorrect, awarding the machine learning algorithm a number of points, or the like) or may be specific (e.g., providing the correct output). For example, the machine learning algorithm 101 may be asked to detect faces in photographs. Based on an output, the feedback system 151 may indicate a score (e.g., 75% accuracy, an indication that the guess was accurate, or the like) or a specific response (e.g., specifically identifying where the face was located).

The artificial neural network 101 may be supported or replaced by other forms of machine learning. For example, one or more of the nodes of artificial neural network 101 may implement a decision tree, associational rule set, logic programming, regression model, cluster analysis mechanisms, Bayesian network, propositional formulae, generative models, and/or other algorithms or forms of decision-making. The artificial neural network 101 may effectuate deep learning.

A large language model may be a language model characterized by its large size. Their size is enabled by AI accelerators, which are able to process vast amounts of text data, mostly scraped from the Internet. The artificial neural networks which are built can contain from tens of millions and up to billions of weights and are (pre-) trained using self-supervised learning and semi-supervised learning. Transformer architecture contributed to faster training.

As language models, they work by taking an input text and repeatedly predicting the next token or word. Up to 2020, fine tuning was the only way a model could be adapted to be able to accomplish specific tasks. Larger sized models, such as GPT-3, however, can be prompt-engineered to achieve similar results. They are thought to acquire embodied knowledge about syntax, semantics and “ontology” inherent in human language corpora large language models are trained using self-supervised learning or semi-supervised learning. This means that they are trained on large amounts of unlabeled text. Large language models can adjust their internal parameters and learn from new inputs from users over time.

Large language models are trained to predict the next word in a sentence based on the previous input sentence. This is a self-supervised learning task because you are not defining separate output labels. The process is repeated until the model reaches an acceptable level of accuracy. Some large language models, like InstructGPT and ChatGPT, use both supervised learning and reinforcement learning. The combination of the two is crucial for optimal performance.

Logically, many learning algorithms may be used. In one embodiment, referring to FIG. 3, the learning algorithm may include a convolutional neural network 510 (CNN) and a transformer 320. In one embodiment, the CNN 310 may determine one or more features 351-354 for each user 341-344. In one example, the CNN may determine the features 351-354 which may be a set of numbers but the amount of features 351-354 may be varied up or down depending on many factors.

The CNN may be trained on millions of past claims and may have learned to understand the value of claims. This CNN may be novel because it has been created and trained on claim data that may be proprietary to the insurance company. Logically, other types of learning algorithms in the may be used. For example, the learning algorithm may be a fully connected neural network (FCN) in one embodiment.

In training, the transformer 320 may take the features 351-354 of multiple claims 341-344 of a similar type (the outputs of the CNN) as well as additional data such any additional information provided by the insured 360 to create a model. Once the model is trained, the transformer may generate predictions of the claim resolutions 370. In some embodiments, the claim resolution 370 may be in real time. The transformer 320 used in this invention may be trained on a dataset specifically created for claim resolutions 370.

The trained model which may be in the transformer 320 may take the features of users-344 as well as outside information in order to predict the claim resolutions. The learning algorithm also may analyze other relevant information about the claim.

### Computing Environment

FIG. 9 may be a high-level block diagram of an example computing environment 400 for the system 100 and methods (e.g., method 300) as described herein. The computing device 400 may include a server, a mobile computing device, a cellular phone, a tablet computer, an electronic reader, a virtual reality headset, an artificial reality headset, a Wi-Fi-enabled device or other personal computing device capable of wireless or wired communication, a thin client, or other known type of computing device (e.g., a mobile computing device 104, a merchant computer system 106, a payment network system 108 and a payment device issuer system 111, etc.). Logically, the computing device 400 may be designed and built to specifically execute certain tasks.

As will be recognized by one skilled in the art, in light of the disclosure and teachings herein, other types of computing devices can be used that have different architectures. Processor systems similar or identical to the example systems and methods described herein may be used to implement and execute the example systems and methods described herein. Although the example system 400 is described below as including a plurality of peripherals, interfaces, chips, memories, etc., one or more of those elements may be omitted from other example processor systems used to implement and execute the example systems and methods. Also, other components may be added.

As shown in FIG. 9, the computing device 401 may include a processor 402 that is coupled to an interconnection bus. The processor 402 may include a register set or register space 404, which is depicted in FIG. 9 as being entirely on-chip, but which could alternatively be located entirely or partially off-chip and directly coupled to the processor 402 via dedicated electrical connections and/or via the interconnection bus. The processor 402 may be any suitable processor, processing unit or microprocessor. Although not shown in FIG. 9, the computing device 401 may be a multi-processor device and, thus, may include one or more additional processors that are identical or similar to the processor 402 and that are communicatively coupled to the interconnection bus.

The processor 402 of FIG. 9 may be coupled to a chipset 406, which includes a memory controller 408 and a peripheral input/output (I/O) controller 410. As is well known, a chipset may typically provide I/O and memory management functions as well as a plurality of general purpose and/or special purpose registers, timers, etc. that are accessible or used by one or more processors coupled to the chipset 406. The memory controller 408 may perform functions that enable the processor 402 (or processors if there are multiple processors) to access a system memory 412 and a mass storage memory 414, that may include either or both of an in-memory cache (e.g., a cache within the memory 412) or an on-disk cache (e.g., a cache within the mass storage memory 414).

The system memory 412 may include any desired type of volatile and/or non-volatile memory such as, for example, static random access memory (SRAM), dynamic random access memory (DRAM), flash memory, read-only memory (ROM), etc. The mass storage memory 414 may include any desired type of mass storage device. For example, the computing device 401 may be used to implement a module 416 (e.g., the various modules as herein described). The mass storage memory 414 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 401, the systems and methods described herein. Thus, a module, block, function, operation, procedure, routine, step, and method can be implemented in hardware, firmware, and/or software.

In one embodiment, program modules and routines may be stored in mass storage memory 414, loaded into system memory 412, and executed by a processor 402 or may be provided from computer program products that are stored in tangible computer-readable storage mediums (e.g. RAM, hard disk, optical/magnetic media, etc.).

The peripheral I/O controller 410 may perform functions that enable the processor 402 to communicate with a peripheral input/output (I/O) device 424, a network interface 426, a local network transceiver 428, (via the network interface 426) via a peripheral I/O bus. The I/O device 424 may be any desired type of I/O device such as, for example, a keyboard, a microphone, an image sensor, a display (e.g., a liquid crystal display (LCD), a cathode ray tube (CRT) display, etc.), a navigation device (e.g., a mouse, a trackball, a capacitive touch pad, a joystick, etc.), etc. The I/O device 424 may be used with the module 416, etc., to receive data from the transceiver 428, send the data to the components of the system 100, and perform any operations related to the methods as described herein. The local network transceiver 428 may include support for a Wi-Fi network, Bluetooth, Infrared, cellular, or other wireless data transmission protocols. In other embodiments, one element may simultaneously support each of the various wireless protocols employed by the computing device 401. For example, a software-defined radio may be able to support multiple protocols via downloadable instructions. In operation, the computing device 401 may be able to periodically poll for visible wireless network transmitters (both cellular and local network) on a periodic basis. Such polling may be possible even while normal wireless traffic is being supported on the computing device 401. The network interface 426 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 408 and the I/O controller 410 are depicted in FIG. 9 as separate functional blocks within the chipset 406, the functions performed by these blocks may be integrated within a single integrated circuit or may be implemented using two or more separate integrated circuits. The computing environment 400 may also implement the module 416 on a remote computing device 430. The remote computing device 430 may communicate with the computing device 401 over an Ethernet link 432. In some embodiments, the module 416 may be retrieved by the computing device 401 from a cloud computing server 434 via the Internet 436. When using the cloud computing server 434, the retrieved module 416 may be programmatically linked with the computing device 401. The module 416 may be a collection of various software playgrounds including artificial intelligence software and document creation software or may also be a Java® applet executing within a Java® Virtual Machine (JVM) environment resident in the computing device 401 or the remote computing device 430. The module 416 may also be a “plug-in” adapted to execute in a web-browser located on the computing devices 401 and 430. In some embodiments, the module 416 may communicate with back end components 438 via the Internet 436.

The system 400 may include but is not limited to any combination of a LAN, a MAN, a WAN, a mobile, a wired or wireless network, a private network, or a virtual private network. Moreover, while only one remote computing device 430 is illustrated in FIG. 9 to simplify and clarify the description, it is understood that any number of client computers may be supported and may be in communication within the system 400.

Additionally, certain embodiments may be described herein as including logic or a number of components, modules, blocks, or mechanisms. Modules and method blocks may constitute either software modules (e.g., code or instructions embodied on a machine-readable medium or in a transmission signal, wherein the code is executed by a processor) or hardware modules. A hardware module may be a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” may be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” may refer to a hardware module. Considering embodiments in which hardware modules are temporarily configured (e.g., programmed), each of the hardware modules need not be configured or instantiated at any one instance in time. For example, where the hardware modules include a processor configured using software, the processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification may be presented in terms of algorithms or symbolic representations of operations on data stored as bits or binary digital signals within a machine memory (e.g., a computer memory). These algorithms or symbolic representations may be examples of techniques used by those of ordinary skill in the data processing arts to convey the substance of their work to others skilled in the art. As used herein, an “algorithm” may be a self-consistent sequence of operations or similar processing leading to a desired result. In this context, algorithms and operations may involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, may be merely convenient labels and are to be associated with appropriate physical quantities. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “embodiments,” “some embodiments” or “an embodiment” or “teaching” may mean that a particular element, feature, structure, or characteristic described in connection with the embodiment is included in at least one embodiment. The appearances of the phrase “in some embodiments” or “teachings” in various places in the specification may not necessarily all be referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments may not be limited in this context.

Further, the figures depict preferred embodiments for purposes of illustration only. One skilled in the art may be readily recognize from the following discussion that alternative embodiments of the structures and methods illustrated herein may be employed without departing from the principles described herein

Upon reading this disclosure, those of skill in the art may appreciate still additional alternative structural and functional designs for the systems and methods described herein through the disclosed principles herein. Thus, while particular embodiments and applications have been illustrated and described, it is to be understood that the disclosed embodiments may not be limited to the precise construction and components disclosed herein. Various modifications, changes and variations, which may be apparent to those skilled in the art, may be made in the arrangement, operation and details of the systems and methods disclosed herein without departing from the spirit and scope defined in any appended claims.

1. A method of creating an electronic story comprising:
receiving a user prompt used at a story generation server;
submitting the user prompt to artificial intelligence system trained using previously written stories;
using the artificial intelligence system, generating text for an electronic story file;
communicating the text to a scene generation system;
in the scene generation system,
analyzing the text for scene information;
determining scene information;
communicating scene information to graphics processor;
in the graphics processor, generating graphics for the story based on the scene information.

2. The method of claim 1, wherein the graphics comprise images, animated images or videos.

3. The method of claim 1, further comprising combining the graphics with text related to the graphics to create a story file.

4. The method of claim 1, wherein the graphics are created for a virtual reality viewer or an augmented reality viewer.

5. The method of claim 1, where the story file is communicated to a user computing device.

6. The method of claim 1, wherein the story file is communicated to a web portal.

7. The method of claim 4, wherein the user computing device is a virtual and/or augmented reality viewing device.

8. The method of claim 7, wherein the file is communicated using a known protocol.

9. The method of claim 7, wherein the electronic story file is accessed using an API.

10. A tangible computer readable medium comprising computer executable instructions for creating an electronic story, the instructions comprising instructions for:
receiving a user prompt used at a story generation server;
submitting the user prompt to artificial intelligence system trained using previously written stories;
using the artificial intelligence system, generating text for an electronic story file;
communicating the text to a scene generation system;
in the scene generation system,
analyzing the text for scene information;
determining scene information;
communicating scene information to graphics processor;
in the graphics processor, generating graphics for the story based on the scene information.

11. The tangible computer readable medium of claim 10, wherein the graphics comprise images, animated images or videos.

12. The tangible computer readable medium of claim 10, further comprising combining the graphics with text related to the graphics to create a story file.

13. The tangible computer readable medium of claim 10, where the story file is communicated to a user computing device.

14. The tangible computer readable medium of claim 10, wherein the story file is communicated to a web portal.

15. The tangible computer readable medium of claim 14, wherein the file is communicated using a known protocol.

16. The tangible computer readable medium of claim 14, wherein the electronic story file is accessed using an API.

17. A computer system comprising a processor, a memorable and an input-output circuit, the processor being physically configured according to computer executable instructions for creating an electronic story, the instructions comprising instruction for:
receiving a user prompt used at a story generation server;
submitting the user prompt to artificial intelligence system trained using previously written stories;
using the artificial intelligence system, generating text for an electronic story file;
communicating the text to a scene generation system;
in the scene generation system,
analyzing the text for scene information;
determining scene information;
communicating scene information to graphics processor;
in the graphics processor, generating graphics for the story based on the scene information.

18. The computer system of claim 17, wherein the graphics comprise images, animated images or videos.

19. The computer system of claim 17, further comprising computer executable instructions for combining the graphics with text related to the graphics to create a story file.

20. The computer system of claim 17, wherein the story file is communicated via at least one of:
a web portal;
a file transfer using a known protocol; and
an API.
